(19) United States
(12) Patent Application Publication
(10) Pub. No.: US 2017/0052659 A1
(43) Pub. Date: Feb. 23, 2017

(54) COMPUTER-IMPLEMENTED METHOD FOR PROVIDING A BROWSER CONTEXTUAL ASSISTANT IN A GRAPHICAL USER INTERFACE ON A DISPLAY SCREEN OF AN ELECTRONIC DEVICE

(71) Applicant: YANDEX EUROPE AG, Luzem (CH)

(72) Inventors: Roman Kirillovitch IVANOV, Moscow (RU); Alexey Andreevich DOTSENKO, Moscow (RU)

(21) Appl. No.: 15/308,516

(22) PCT Filed: Jan. 6, 2015
(86) PCT No.: PCT/IB15/50103

§ 371 Date: Nov. 2, 2016

(30) Foreign Application Priority Data
Jun. 30, 2014 (RU) 2014126469

(51) Int. Cl. G06F 3/0482; G06F 17/30

(52) U.S. Cl. CPC G06F 3/0482; G06F 17/30477; G06F 17/3097; G06F 17/2235

(57) ABSTRACT

A computer-implemented method for providing a browser contextual assistant on an electronic device, the method comprising: (I) receiving, by a server from the electronic device user-selected information appearing in the graphical user interface; (II) effecting, by the server, a search in a plurality of search verticals in respect of the user-selected information; (III) determining which of the plurality of search verticals is the most relevant search vertical; (IV) rendering a menu element, the menu element selected from menu items and data for inclusion into the browser contextual assistant, the at least one of the menu item and the data being related to the most relevant search vertical; (V) sending, by the server to the electronic device the menu element.

### CROSS-REFERENCE

The present application claims priority to Russian Patent Application No. 2014126469, filed Jun. 30, 2014, entitled “COMPUTER-IMPLEMENTED METHOD FOR PROVIDING A BROWSER CONTEXTUAL ASSISTANT IN A GRAPHICAL USER INTERFACE ON A DISPLAY SCREEN OF AN ELECTRONIC DEVICE” the entirety of which is incorporated herein.

### FIELD

The present technology relates to computer-implemented method for providing a browser contextual assistant in a graphical user interface on a display screen of an electronic device.

### BACKGROUND

Context menus in a graphical user interface that appear upon user interaction, such as a right-click mouse operation, are well known. Context menus are a kind of browser assistants. Usually a right-click mouse operation over a part of a display screen would effect producing a menu which context is fully or partially predetermined by the features of the content being displayed on that part of the display screen (i.e. an object in question). A context menu is then made available to the user that contains commands and actions (or shortcuts to commands and actions) that pertain to the object in question. For example, different context menus may appear if a mouse operation was conducted over a single text word, over a paragraph or other text block, a picture, a drawing figure, a hyperlink, a video, a fill-in form, or a mix of them.

A mouse operation may affect appearance of a contextual menu in a different way depending on whether that operation is affected over a highlighted or over non-highlighted context.

As an example of said above, in the web browser Internet Explorer™, the same enlistment of commands will appear in the contextual menu if one right-clicks over the selected word “Michael” or “Red”; another set of commands will appear if one right-clicks over a non-selected word “Michael” or “Red”; a third set of commands will appear if one right-clicks over a hyperlink displayed as underlined words “Michael” or “Red”. The similar result would be achieved if one would use Google Chrome™ web browser.

Consequentially, the enlistment of commands in the contextual menu will be different when one right clicks over the word “hummingbird” or over a picture of a hummingbird, because features of these elements are different.

Depending on the user selection, conventional technologies provide for appearance of one or a plurality of context menus, wherein all these context menus contain sets of pre-determined options.

In the document entitled “Using Context Menus (Windows)” published by Microsoft on Feb. 8, 2011 (http://msdn.microsoft.com/en-us/library/ms701740(v=VS.85).aspx, downloaded on Jun. 13, 2014), there is mentioned that “[a] context menu offers a list of relevant commands that apply to the current selection or task.” All the samples in that publication demonstrate a context menu as on-object oriented user interface. The semantic meaning of the selection, however, is not taken into consideration.

An attempt to take into consideration not only the technical features of the selection, but also its semantic meaning, was undertaken by CABALLERO et all in their patent application “Method and System for Contextual Activation of Web Services” (WO 6005/045690 A1).

The solution for enabling interactive search of a remotely located information repository, suggested by CABALLERO et all, provides a web page having a tag (an instruction to acquire code from a remote location). The tag is activated when the user accesses the web page. Executable code is then downloaded to the user's computer which, when run in his browser, causes the browser to become contextually responsive. In other words, the suggested solution functions for web pages only specially designed to that effect. The invention will not function if a web page does not have the tag. Therefore, many web pages or, to be accurate, the vast majority of web pages potentially present in the World Wide Web (or “www” for short), would simply not work with the solution disclosed by Caballero et all.

There is another aspect of the prior art which is worth discussing for the sake of understanding background of the instant technology. A hovering with a pointing device over a part of a graphical user interface, or the right-click mouse operation over a part of a graphical user interface, does not necessarily mean that a user wants to be presented with a contextual menu. Sometimes a user just needs an additional information or help with regard to an element displayed on a display screen. For example, as it is shown on FIG. 1, on the web site of Wikipedia, once a user hovers a mouse over a hyperlink designated as “Log in” 102 in the top right corner, the following prompt 104 will appear: “You're encouraged to log in; however, it's not mandatory. [alt-o]”.

In many instances, as in example immediately above, the content to be provided as an additional information in response to hovering a pointing device is defined by web developers. However, it is not necessarily the case. For example, in the web browser Internet Explorer, when a user selects a text “101 Independence Avenue, SE, Washington, D.C. 20540”, being the address of the Library of Congress, the user will be provided with the contextual menu having a command “Map with Bing”. When the user hovers a mouse over that command, as it is shown on FIG. 2, a small square in the same window showing the address on the map will appear.

The solution implemented in the web browser Internet Explorer however could be improved, because the suggestion to show an object on the map is displayed all the time when a user selects a plain text, irrespective of whether the selected plain text is in fact an address or not, as it can be seen from FIG. 3. If a user selects a word “recognized”, which is not an address or a place, the active menu item “Map with Bing” will still appear. When the user hovers a mouse over that command, he or she will see the following message: “The selected text is not a location or it cannot be found”. In other words, the suggestion to show an object on the map is not defined by the semantic meaning of the text itself, but rather by the mere fact that a text was selected.

There is therefore a need for further improvements of methods, systems and apparatus for assisting users of electronic devices.

### SUMMARY

It is an object of the present technology to ameliorate at least some of the inconveniences present in the prior art.

In one aspect, implementations of the present technology provide a computer-implemented method for providing a browser contextual assistant in a graphical user interface on a display screen of an electronic device, the electronic device having a user input device, the method comprising: receiving, by a server from the electronic device via a communications network, user-selected information appearing in the graphical user interface; effecting, by the server, a search in a plurality of search verticals in respect of the user-selected information; determining, by the server, which of the plurality of search verticals is the most relevant search vertical; rendering a menu element, the menu element selected from menu items and data for inclusion into a browser contextual assistant to be displayed by the electronic device in the graphical user interface in respect of the user-selected information, the at least one of the menu item and the data being related to the most relevant search vertical; sending, by the server to the electronic device via the communications network, the menu element.

In some implementations, rendering the menu element is rendering plurality of menu elements, the at least two menu elements being related to at least one most relevant search vertical, and sending, by the server to the electronic device via the communications network, the menu element is sending plurality of menu elements.

In some implementations, the computer-implemented method further comprising sending a non-context-sensitive menu element for inclusion into the browser contextual assistant.

In some implementations, the menu elements are ranked.

In some implementations, the computer-implemented method further comprising: (i) receiving, by the server from the electronic device via the communications network, information other than the user-selected information; and (ii) effecting, by the server, the search in the plurality of search verticals in respect of the user-selected information and at least some of the information other than the user-selected information.

In some implementations, the information other than the user-selected information is selected from textual elements and graphical elements in proximity to the user-selected information in the graphical user interface.

In some implementations, the information other than the user-selected information is selected from a characteristic of the electronic device and a location of the electronic device.

In some implementations, the computer-implemented method further comprising: (i) sending, by the server to the electronic device via the communications network, instruction to display, by the electronic device in the graphical user interface in respect of the user-selected information, a graphical element indicating a presence of the browser contextual assistant; and (ii) receiving, by the server from electronic device via the communications network, an indication of selection of the graphical element indicating the present of the browser contextual assistant by a user of the electronic device.

In some implementations, the computer-implemented method further comprising: receiving, by the server from the electronic device via the communications network, a user-selected one of the menu item and the data; taking an action, by the server, in response to the received user-selected one of the menu item and the data; and sending, by the server to the electronic device via the communications network, information related to the taken action.

In another aspect, implementations of the present technology provide a computer-implemented method for providing a browser contextual assistant in a graphical user interface on a display screen of an electronic device, the electronic device having a user input device, the method comprising: displaying information on the display screen; receiving from a user of the electronic device via the user input device a selection of at least some of the displayed information; sending, by the electronic device to a server via a communications network, user-selected information; receiving by the electronic device from the server the menu element selected by the server from menu items and data for inclusion into a browser contextual assistant to be displayed by the electronic device in the graphical user interface in respect of the user-selected information, the at least one of the menu item and the data being related to the most relevant search vertical; and displaying on the display screen a graphical element providing the browser contextual assistant.

In some implementations, sending, by the electronic device to a server via a communications network, user-selected information includes sending other than the user-selected information.

In some implementations, the information other than the user-selected information includes at least one of textual elements and graphical elements in proximity to the user-selected information in the graphical user interface.

In some implementations, the information other than the user-selected information includes at least one of a characteristic of the electronic device and a location of the electronic device.

In some implementations, the browser contextual assistant includes a non-menu item.

In some implementations, menu items in the browser contextual assistant are ranked.

In some implementations, the computer-implemented method further comprising: (i) displaying on the display screen a graphical element indicating a presence of the browser contextual assistant; and (ii) receiving from the user of the electronic device via the user input device a selection of the graphical element indicating the present of the browser contextual assistant.

In some implementations, the computer-implemented method further comprising: (i) receiving from the user of the electronic device via the user input device a user-selected one of the at least one of the menu item and the data; (ii) sending the user-selected one of the at least one of a menu item and data to the server by the electronic device via the communications network; (iii) receiving information from the server by the electronic device via the communications network in response to the sent user-selected one of the at least one of a menu item and data.

In yet another aspect, implementations of the present technology provide a server. The server comprises a computer usable information storage medium. The computer usable information storage medium includes computer-readable commands. The commands, when executed, cause the server to: receive, from an electronic device via a communications network, user-selected information appearing in a graphical user interface; effect a search in a plurality of search verticals in respect of the user-selected information; determine which of the plurality of search verticals is the most relevant search vertical; render a menu element, the menu element selected from menu items and data for inclusion into a browser contextual assistant to be displayed by the electronic device in the graphical user interface in respect of the user-selected information, the at least one of the menu item and the data being related to the most relevant search vertical; send to the electronic device via the communications network the menu element.

In some implementations the menu element is plurality of menu elements, wherein at least two menu elements being related to at least one most relevant search vertical, and sending the menu element is sending plurality of menu elements.

In some implementations, computer readable commands, when executed, further cause the processor to send a non-context-sensitive menu element for inclusion into the browser contextual assistant.

In some implementations, computer readable commands, when executed, further cause the server to rank the menu elements.

In some implementations, computer readable commands, when executed, further cause the server to: (i) receive from the electronic device via the communications network information other than the user-selected information; and (ii) effect the search in the plurality of search verticals in respect of the user-selected information and at least some of the information other than the user-selected information.

In some implementations, the information other than the user-selected information is selected from textual elements and graphical elements in proximity to the user-selected information in the graphical user interface.

In some implementations, the information other than the user-selected information is selected from a characteristic of the electronic device and a location of the electronic device.

In some implementations, computer readable commands, when executed, further cause the server to: (i) send to the electronic device via the communications network instruction to display, by the electronic device in the graphical user interface in respect of the user-selected information, a graphical element indicating a presence of the browser contextual assistant; and (ii) receive, from electronic device via the communications network, an indication of selection of the graphical element indicating the present of the browser contextual assistant by a user of the electronic device.

In some implementations, computer readable commands, when executed, further cause the server to: (i) receive from the electronic device via the communications network a user-selected one of the menu item and the data; (ii) take an action in response to the received user-selected one of the menu item and the data; and (iii) send to the electronic device via the communications network information related to the taken action.

In yet another aspect, implementations of the present technology provide an electronic device. The electronic device has a display screen. The electronic device has a user input device. The electronic device has a computer usable information storage medium. The electronic device has a processor. The processor is coupled to the display screen. The processor is coupled to the user input device. The processor is coupled to the computer usable information storage medium. The processor is configured to have access to computer readable commands. The commands, when executed, cause the processor to: display information on the display screen; receive from a user of the electronic device via the user input device a selection of at least some of the displayed information; send, by the electronic device to a server via a communications network, user-selected information; receive by the electronic device from the server the menu element selected by the server from menu items and data for inclusion into a browser contextual assistant to be displayed by the electronic device in the graphical user interface in respect of the user-selected information, the at least one of the menu item and the data being related to the most relevant search vertical; and display on the display screen a graphical element providing the browser contextual assistant.

In some implementations, sending by the electronic device to a server via a communications network user-selected information includes sending other than the user-selected information.

In some implementations, the information other than the user-selected information includes at least one of textual elements and graphical elements in proximity to the user-selected information in the graphical user interface.

In some implementations, the information other than the user-selected information includes at least one of a characteristic of the electronic device and a location of the electronic device.

In some implementations, the browser contextual assistant includes a non-menu item.

In some implementations, menu items in the browser contextual assistant are ranked.

In some implementations, commands, when executed, further cause the processor to: (i) display on the display screen a graphical element indicating a presence of the browser contextual assistant; and (ii) receive from the user of the electronic device via the user input device a selection of the graphical element indicating the present of the browser contextual assistant.

In some implementations, commands, when executed, further cause the processor to: (i) receive from the user of the electronic device via the user input device a user-selected one of the at least one of the menu item and the data; send the user-selected one of the at least one of a menu item and data to the server by the electronic device via the communications network; receive information from the server by the electronic device via the communications network in response to the sent user-selected one of the at least one of a menu item and data.

In the context of the present specification, a “server” is a computer program that is running on appropriate hardware and is capable of receiving requests (e.g. from electronic devices) over a network, and carrying out those requests, or causing those requests to be carried out. The hardware may be one physical computer or one physical computer system, but neither is required to be the case with respect to the present technology. In the present context, the use of the expression a “server” is not intended to mean that every task (e.g. received instructions or requests) or any particular task will have been received, carried out, or caused to be carried out, by the same server (i.e. the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “electronic device” is any computer hardware that is capable of running software appropriate to the relevant task at hand. Thus, some (non-limiting) examples of electronic devices include personal computers (desktops, laptops, netbooks, etc.), smartphones, and tablets, as well as network equipment such as routers, switches, and gateways. It should be noted that a device acting as a electronic device in the present context is not precluded from acting as a server to other electronic devices. The use of the expression “a electronic device” does not preclude multiple electronic devices being used in receiving/sending, carrying out or causing to be carried out any task or request, or the consequences of any task or request, or steps of any method described herein.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, the expression “information” includes information of any nature or kind whatsoever capable of being stored in a database. Thus information includes, but is not limited to audiovisual works (images, movies, sound records, presentations etc.), data (location data, numerical data, etc.), text (opinions, comments, questions, messages, etc.), documents, spreadsheets, etc.

In the context of the present specification, the expression “component” is meant to include software (appropriate to a particular hardware context) that is both necessary and sufficient to achieve the specific function(s) being referenced.

In the context of the present specification, the expression “computer usable information storage medium” is intended to include media of any nature and kind whatsoever, including RAM, ROM, disks (CD-ROMs, DVDs, floppy disks, hard drivers, etc.), USB keys, solid state-drives, tape drives, etc.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

In the context of the present specification, the term “vertical” is meant to connote a search performed on a subset of a larger set of data, the subset having been grouped pursuant to an attribute of data. For example, there can be such verticals as images, video, audio, news, market, maps, books, applications, tickets, apps, celebrity, movies, sports, finance, games, dating, shopping, encyclopaedias, dictionaries, translations, events, social networks, realty, poetry, traffic, television programs, and others. In the context of the present specification, the general web search shall be considered to be one of vertical searches. For better clarity, where the general web search is mentioned specifically, this shall not eliminate the fact that the general web search is a kind of vertical search.

Implementations of the present technology each have one or more of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a partial screen shot depicting a Wikipedia web page opened in Internet Explorer™ web browser with a prompt displayed therein, according to prior art.

FIG. 2 is a partial screen shot of a web page opened in Internet Explorer™ web browser showing a context menu and a map (prior art).

FIG. 3 is another partial screen shot of a web page opened in Internet Explorer™ web browser showing a context menu and a window for displaying a map (prior art).

FIG. 4 is a schematic diagram depicting a system 400, the system 400 being implemented in accordance with non-limiting embodiments of the present technology.

FIG. 5 is a schematic presentation of a browser contextual assistant being implemented according with non-limiting embodiments of the present technology.

FIG. 6 is a block diagram depicting a method 600, the method 600 being implemented within the system 400 of FIG. 4 and being implemented according with non-limiting embodiments of the present technology.

FIG. 7 is a block diagram depicting a method 600, the method 700 being implemented within the system 400 of FIG. 4 and being implemented according with other non-limiting embodiments of the present technology.

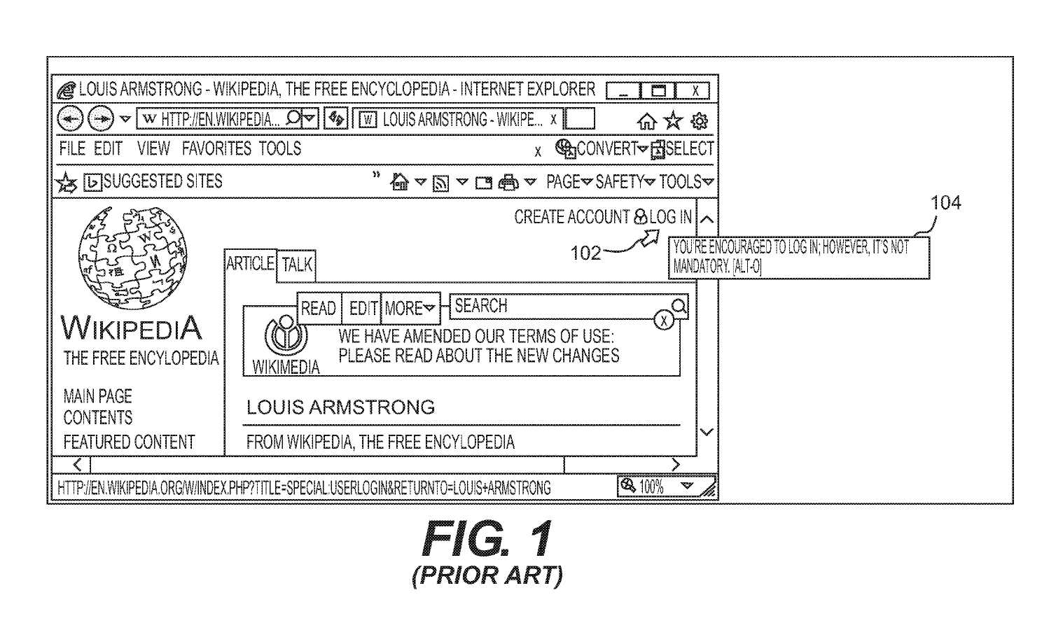

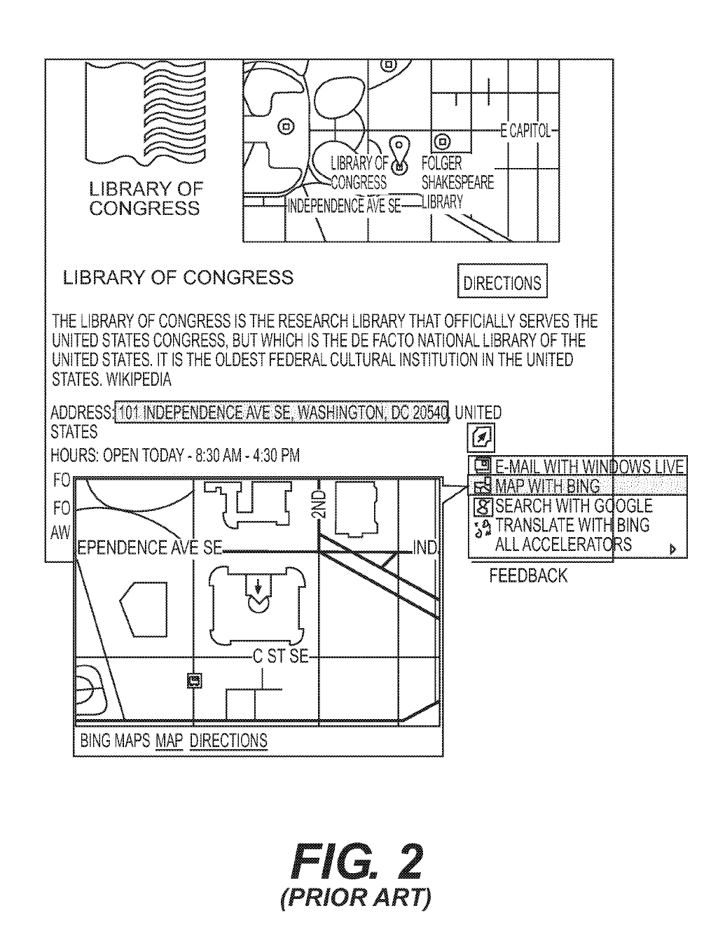

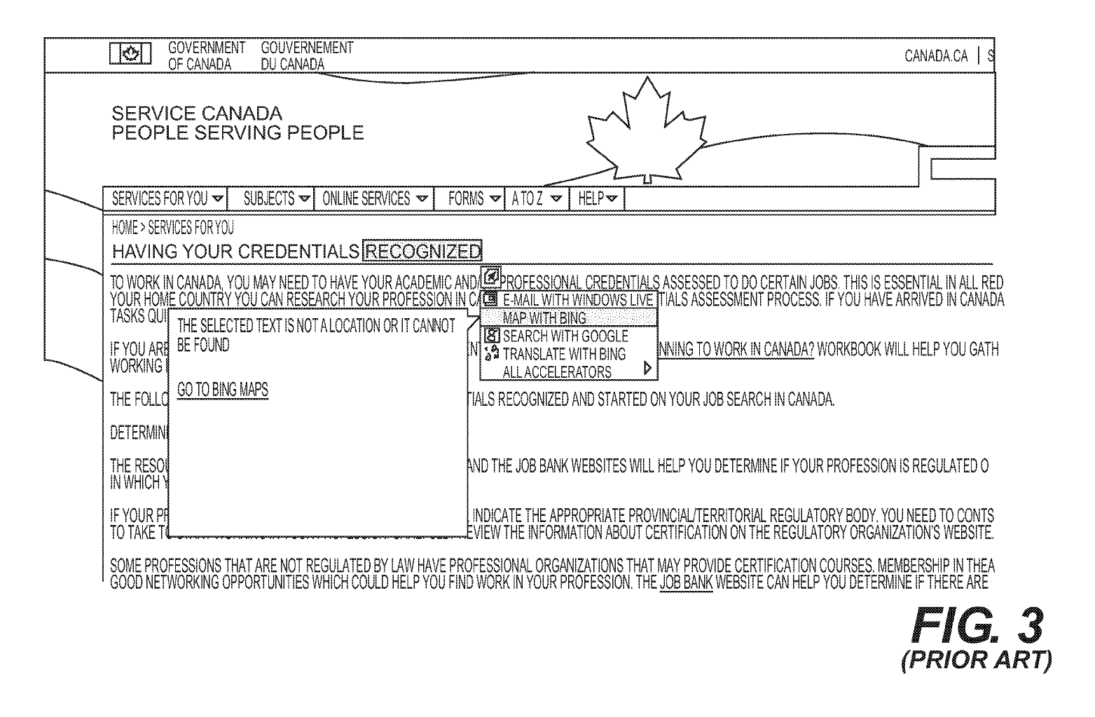

### DETAILED DESCRIPTION

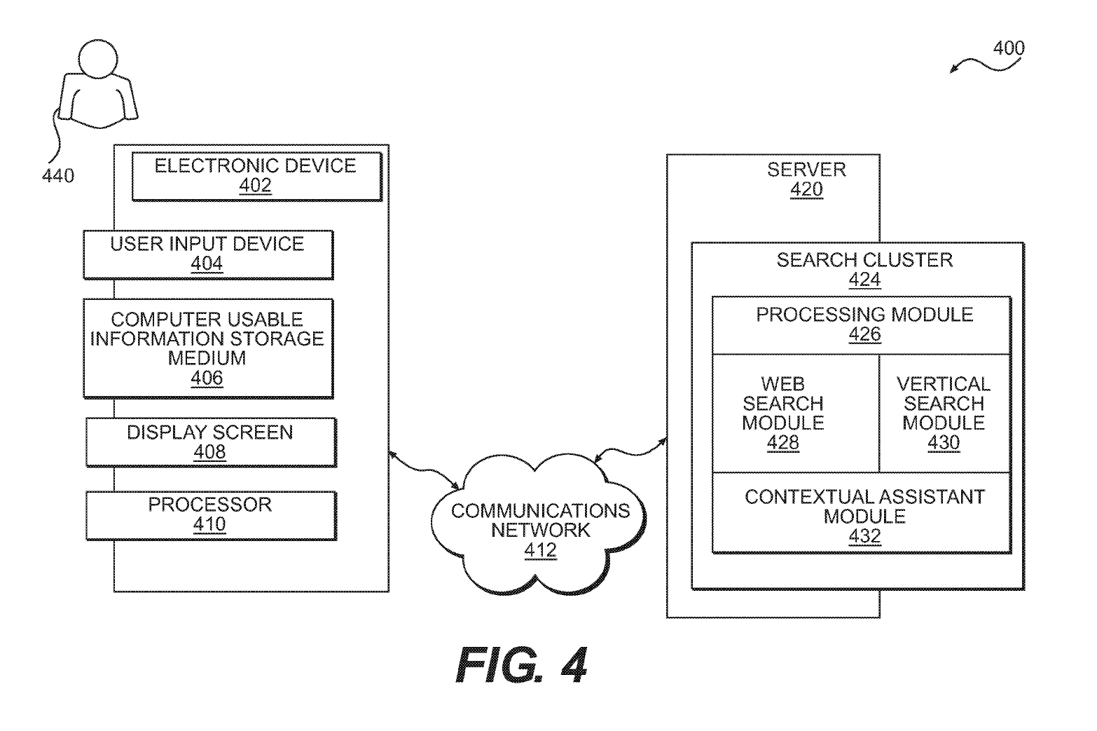

Referring to FIG. 4, there is shown a schematic diagram of a system 400, the system 400 being suitable for implementing non-limiting embodiments of the present technology. It is to be expressly understood that the system 400 is depicted as merely as an illustrative implementation of the present technology. Thus, the description thereof that follows is intended to be only a description of illustrative examples of the present technology. This description is not intended to define the scope or set forth the bounds of the present technology. In some cases, what are believed to be helpful examples of modifications to the system 400 may also be set forth below. This is done merely as an aid to understanding, and, again, not to define the scope or set forth the bounds of the present technology. These modifications are not an exhaustive list, and, as a person skilled in the art would understand, other modifications are likely possible. Further, where this has not been done (i.e. where no examples of modifications have been set forth), it should not be interpreted that no modifications are possible and/or that what is described is the sole manner of implementing that element of the present technology. As a person skilled in the art would understand, this is likely not the case. In addition it is to be understood that the system 400 may provide in certain instances simple implementations of the present technology, and that where such is the case they have been presented in this manner as an aid to understanding. As persons skilled in the art would understand, various implementations of the present technology may be of a greater complexity.

The system 400 comprises an electronic device 402. The electronic device 402 is typically associated with a user 440 and, as such, can sometimes be referred to as a “client device”. It should be noted that the fact that the electronic device 402 is associated with the user does not need to suggest or imply any mode of operation such as a need to log in, a need to be registered or the like.

The implementation of the electronic device 402 is not particularly limited, but as an example, the electronic device 402 may be implemented as a personal computer (desktops, laptops, netbooks, etc.) or as a wireless communication device (a smartphone, a tablet and the like).

The electronic device 402 comprises a user input device 404. How the user input device 404 is implemented is not particularly limited and may depend on how the electronic device 402 is implemented. The user input device 404 may include any mechanism for providing user input to the processor 410. The user input device 404 can be a keyboard, or a mouse, and so on. The input device 404 is not limited to any specific input methodology, but could be arranged by a virtual button on a touch-screen display or a physical button on the cover of the electronic device, for instance.

Merely as an example and not as a limitation, in those embodiments of the present technology where the electronic device 402 is implemented as a wireless communication device (such as a smartphone), user input device 404 can be implemented as an optical interference based user input device. The user input device 404 of one example is a finger/object movement sensing device on which a user performs a gesture and/or presses with a finger. The user input device 404 can identify/track the gesture and/or determines a location of a user's finger on the user input device 404. In the instances where the user input device 404 is executed as the optical interference based user input device, such as touch screen, or multi-touch display, the user input device 404 can further execute functions of the display screen 408.

The user input device 404 is communicatively coupled to a processor 410 and transmits input signals (and output signals where it also operates as the display screen 408) based on various forms of user input for processing and analysis by processor 410.

The electronic device 402 further comprises a computer usable information storage medium 406, also referred to as the local memory 406. Local memory 406 can comprise any type of media, including but not limited to RAM, ROM, disks (CD-ROMs, DVDs, floppy disks, hard drivers, etc.), USB keys, solid state-drives, tape drives, etc. Generally speaking, the purpose of the local memory 406 is to store computer readable commands as well as any other data.

The electronic device 402 further comprises the display screen 408. Display screen 408 can be liquid crystal display (LCD), light emitting diode (LED), Interferometric modulator display (IMOD), or any other suitable display technology. The display screen 408 is generally configured to display a graphical user interface (GUI) that provides an easy to use visual interface between the user 440 of the electronic device 402 and the operating system or application(s) running on the electronic device 402. Generally, the GUI presents programs, files and operational options with graphical images. Display screen 408 is also generally configured to display other information like user data and web resources. Display screen 408 can also be touch based devices such as touch screen. A touch screen is a display that detects the presence and location of user touch inputs. Display screen 408 can also be dual touch or multi-touch displays that can identify the presence, location and movement of a touch inputs. In the instances where the display screen 408 is implemented as a touch based device such as touch screen, or multi-touch display, the display screen 408 can execute functions of the user input device 404.

The display screen 408 is communicatively coupled to processor 410 and receives signals from the processor 410. In instances where display screen 408 is implemented as a touch based device such as touch screen, or multi-touch display, the display screen 408 can also transmit input signals based on various forms of user input for processing and analysis by processor 410.

The electronic device 402 further comprises the above mentioned processor 410. The processor 410 is configured to perform various operations in accordance with a machine-readable program code. The processor 410 is operatively coupled to the user input device 404, to the local memory 406, and to the display screen 408. The processor 410 is configured to have access to computer readable commands which commands, when executed, cause the processor to execute the various routines. As non-limiting examples, the processor 410 described herein can have access to computer readable commands, which commands, when executed, can cause the processor to: display information on the display screen 408; receive from a user 440 of the electronic device 402 via the user input device 404 a selection of at least some of the displayed information; send, by the electronic device 402 to a server 420 via a communications network 412, the user-selected information; receive by the electronic device 402 from the server 420 web content and other data, including menu elements selected by the server 420 and other data for displaying on the display screen 408 of the electronic device 402; display on the display screen 408 a graphical element providing the browser contextual assistant.

The electronic device 402 is coupled to the communications network 412 via a communication link (not separately numbered). In some non-limiting embodiments of the present technology, the communications network 412 can be implemented as the Internet. In other embodiments of the present technology, the communications network 412 can be implemented differently, such as any wide-area communications network, local-area communications network, a private communications network and the like.

How the communication link is implemented is not particularly limited and will depend on how the electronic device 402 is implemented. Merely as an example and not as a limitation, in those embodiments of the present technology where the electronic device 402 is implemented as a wireless communication device (such as a smartphone), the communication link can be implemented as a wireless communication link (such as but not limited to, a 3G communications network link, a 4G communications network link, a Wireless Fidelity, or WiFi® for short, Bluetooth® and the like). In those examples, where the electronic device 402 is implemented as a notebook computer, the communication link can be either wireless (such as the Wireless Fidelity, or WiFi® for short, Bluetooth® or the like) or wired (such as an Ethernet based connection).

It should be expressly understood that implementations for the electronic device 402, the communication link and the communications network 412 are provided for illustration purposes only. As such, those skilled in the art will easily appreciate other specific implementation details for the electronic device 402, the communication link and the communications network 412. As such, by no means, examples provided herein above are meant to limit the scope of the present technology.

The electronic device 402 can establish connections, through the communications network 412, with other devices, such as servers.

Generally describing the electronic device 402 in more details, characteristics of the electronic device 402 may include one or more device properties, such as a geographic location (“geo location”), an Internet Protocol (“IP”) address, a country, an operation system language, the data indicating that the user 440 is logged on a particular social network, and the like. The geo location may be a location identified using an IP address. By way of another non-limiting example, the geo location may be provided by Global Navigation Satellite System (GLONASS), by Global Positioning Systems (“GPS”), or the like, incorporated into the electronic device 402, or other sources of geo location information. The geo location may include a country, region, city, latitude, longitude, and/or ZIP code identified using an IP address. The characteristic of the electronic device 402 may include other attributes and properties associated with the electronic device 402, such as web analytics (e.g., a browser language, a screen resolution, a browser name, etc.).

The system 400 further comprises a server 420 coupled to the communications network 412 via a communication link (not separately numbered). The server 420 can be implemented as a conventional computer server. In an example of an embodiment of the present technology, the server 420 can be implemented as a Dell™ PowerEdge™ Server running the Microsoft™ Windows Server™ operating system. Needless to say, the server 420 can be implemented in any other suitable hardware and/or software and/or firmware or a combination thereof. In the depicted non-limiting embodiment of present technology, the server 420 is a single server. In alternative non-limiting embodiments of the present technology, the functionality of the server 420 may be distributed and may be implemented via multiple servers.

The implementation of the server 420 is well known. However, briefly speaking, the server 420 comprises a communication interface (not depicted) structured and configured to communicate with various entities (such as the electronic device 402, for example and other devices potentially coupled to the communications network 412) via the communications network 412. The server 420 further comprises at least one computer processor (not depicted) operationally connected with the communication interface and structured and configured to execute various processes to be described herein.

The server 420 comprises the search cluster 424. In some implementations, the server 420 and the search cluster can be implemented separately. In those implementations, the server 420 is in communication with or otherwise coupled to the search cluster 424 via a dedicated communication link, or alternatively the server 420 can be coupled to the search cluster 424 via the communications network 412.

The search cluster 424 comprises a processing module 426. The processing module 426, in turn, includes a web search module 428 and a vertical search module 430. The vertical search module 430 has access to (or, otherwise, comprises) a vertical database (not depicted).

Generally speaking the purpose of the search cluster 424 is to (i) conduct searches; (ii) execute analysis of search results and perform ranking of search results; (iii) group results and compile the search query result sets to be outputted to the electronic device 402 within search engine result pages. How the search cluster 424 is configured to execute searches is not particularly limited. Those skilled in the art will appreciate several ways and means to execute the search using the search cluster 424 and as such, several structural components of the search cluster 424 will only be described at a high level.

The processing module 426 can execute several searches, including but not limited to, a general web search and a vertical search. To that end, the processing module 426 comprises (or has access to) the web search module 428. The web search module 428 is configured to perform general web searches, as is known to those of skill in the art.

Even though the web search module 428 is depicted as a single entity, in alternative non-limiting embodiments of the present technology the web search module 428 can also be implemented in a distributed manner.

The processing module 426 further comprises (or has access to) the vertical search module 430. In some alternative embodiments of the present technology, the search module 430 can be implemented as a plurality of vertical search modules. It should be expressly understood that the number of modules within the plurality of vertical search modules is not meant to be a limitation of embodiments of the present technology.

Merely for the purposes of ease of illustration, it shall be assumed that the vertical search module 430 is implemented as an images vertical search domain. As such, it can be said that the vertical search module 430 implements an image vertical search engine or, simply, an image service.

In some non-limiting embodiments of the present technology, any one of the plurality of vertical search modules comprises or has access to one or more databases (not depicted). These one or more databases host data associated with the particular service implemented by the given one of the plurality of vertical search modules.

To that extent, the vertical search module 430 has access to a vertical database (not depicted). Recalling that the vertical search module 430 implements an image service, the vertical database can host a repository of various images.

Also, for the purposes of the description presented herein, the term “vertical” (as in vertical search or in vertical search domain) is meant to connote a search performed on a subset of a larger set of data, the subset having been grouped pursuant to an attribute of data. For example, to the extent that the vertical search module 430 implements an image service, the vertical search module 430 searches a subset (i.e. images) of the set of data (i.e. all the data potentially available for searching), the subset of data being stored in the vertical database.

The processing module 426 further comprises (or has access to) a contextual assistance module 432. Generally speaking, the purpose of the contextual assistance module 432, as a part of the search cluster 424, is to (i) execute analysis of search results, (ii) match certain search results with menu items selected from a pre-determined list of menu items; (iii) detect in the search results the data being suitable for inclusion into a browser contextual assistant; (iv) perform ranking of menu elements; (v) generate the browser contextual assistant from menu elements.

The menu element can be data for inclusion into a browser contextual assistant. The data for inclusion into a browser contextual assistant provides a user with information relevant to the user-selected information and, in some implementations, information relevant to the user-selected information and the information other than user-selected information. Such data for inclusion into the browser contextual assistant is context sensitive due to the fact that the data for inclusion into a browser contextual assistant is selected by the contextual assistance module 432 after the general web search and the vertical searches are completed, and the choice of the menu element is made based on results of the general web search and vertical web searches, as it will be shown when method 600 and method 700 will be described.

The menu element can be a menu item. The menu item allows to a user 440 performing an action.

In some implementation, there can be predetermined list of menu items, the list of menu items accessible by the contextual assistance module 432. Menu items in the list of menu items can be linked to specific types of user queries. For instance, one or both commands “Search images” and “Search music” can be related to queries like “Michael Jackson”. General and vertical searches allow the processing module 426 to determine the search type by analysing results returned by web search module 428 and vertical search module 430. If the performed search demonstrates that image vertical and audio vertical give the most relevant answers, as it can be with search responsive to the query “Michael Jackson”, the contextual assistant module 432 can match the search results with commands “Search images” and “Search music” and generates menu items “Search images” and “Search music” for inclusion into the browser contextual assistant. Such menu items are context sensitive due to the fact that the menu elements were selected by the contextual assistance module 432 after the general web search and the vertical searches were completed, and the choice of the menu items was made based on results of the general web search and vertical web searches.

In some implementations, the contextual assistance module 432 can render more than one menu element. These menu elements can comprise menu items, data for inclusion into a browser contextual assistant, or both.

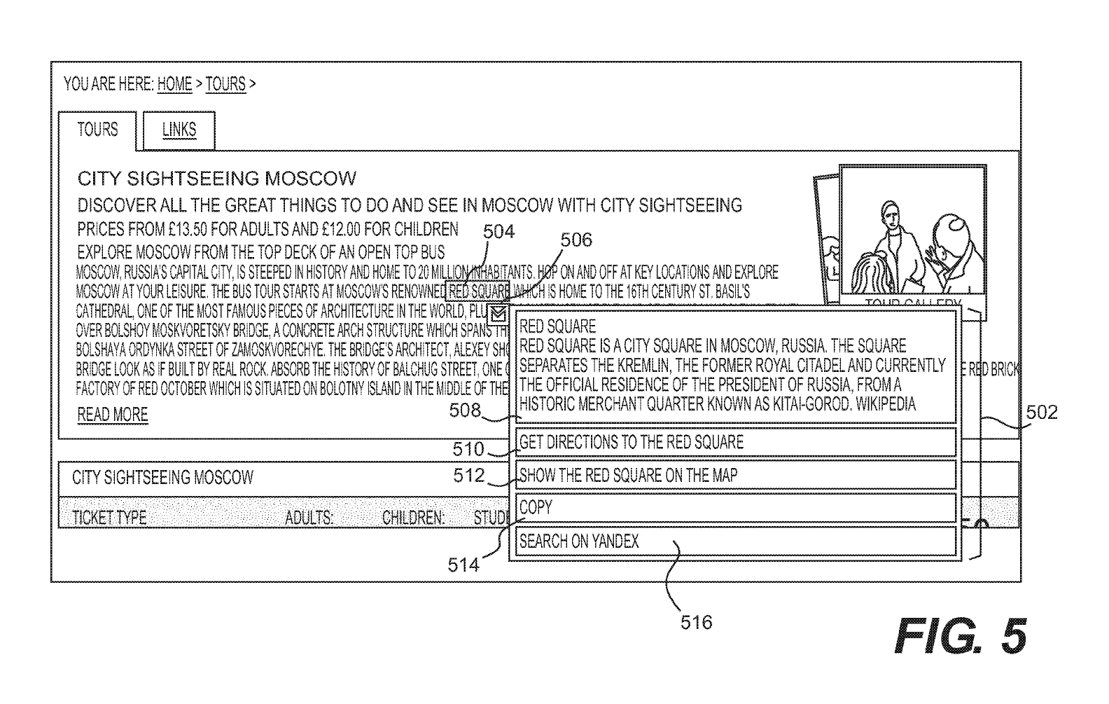

Referring to FIG. 5, there is shown schematic presentation of a browser contextual assistant 502 being implemented according with non-limiting embodiments of the present technology. The browser contextual assistant 502 is shown within a portion of the display screen 408, the display screen 408 displaying a web page. It is to be expressly understood that the browser contextual assistant 502 is depicted as merely as an illustrative implementation of the present technology. Thus, the description thereof that follows is intended to be only a description of illustrative examples of the present technology. This description is not intended to define the scope or set forth the bounds of the present technology. In some cases, what are believed to be helpful examples of modifications to the browser contextual assistant 502 may also be set forth below. This is done merely as an aid to understanding, and, again, not to define the scope or set forth the bounds of the present technology. These modifications are not an exhaustive list, and, as a person skilled in the art would understand, other modifications are likely possible. Further, where this has not been done (i.e. where no examples of modifications have been set forth), it should not be interpreted that no modifications are possible and/or that what is described is the sole manner of implementing that element of the present technology. As a person skilled in the art would understand, this is likely not the case. In addition it is to be understood that the browser contextual assistant 502 may provide in certain instances simple implementations of the present technology, and that where such is the case they have been presented in this manner as an aid to understanding. As persons skilled in the art would understand, various implementations of the present technology may be of a greater complexity.

The FIG. 5 depicts a fragment of a web page “City Sightseeing Moscow” (not numbered). The phrase 504 “Red Square” is the phrase selected by the user 440 by using the user input device 404. In this example, the phrase 504 “Red Square” is selected on the display screen 408 with a mouse.

After selection is made, a graphical element 506 appears, the graphical element 506 indicating a presence of the browser contextual assistant 502. How the graphical element 506 is implemented is not particularly limited. The graphical element 506 can be of any shape and of any color. In some implementations, there can be no graphical element 506 indicating a presence of the browser contextual assistant 502 at all.

After the graphical element 506 indicating a presence of the browser contextual assistant 502 appears, the user 440 can decide whether he or she actually wants to see the browser contextual assistant 502.

If the user 440 does not want to see the browser contextual assistant 502, the user 440 can click outside of the graphical element 506 indicating a presence of the browser contextual assistant 502, whereafter the graphical element 506 disappears, and the browser contextual assistant 502 will not appear at all. Alternatively, in stead of clicking outside of the graphical element 506 indicating a presence of the browser contextual assistant 502, the user 440 can press the button “escape” on a keyboard of the electronic device 102, whereafter the graphical element 506 disappears, and the browser contextual assistant 502 will not appear at all, as well. As a person skilled in the art will understand, there can be other methods to communicate the intent of the user 440 not to open the browser contextual assistant 502.

However, if the user 440 wants to see the browser contextual assistant 502, the user 440 can click on the graphical element 506 indicating a presence of the browser contextual assistant 502, whereafter the browser contextual assistant 502 actually appears as it is shown on FIG. 5. The FIG. 5 illustrates the final state of the web page where the phrase 504 has already been selected, the graphical element 506 has already been displayed to the user, and in response to the user selection of the graphical element 506, the browser contextual assistant 502 has also been displayed.

As a person skilled in the art will understand, there can be other methods to communicate the intent of the user 440 to open the browser contextual assistant 502, such as to press the button “enter” on the keyboard of the electronic device 102.

The browser contextual assistant 502, shown on FIG. 5, comprises five menu elements numbered 508, 510, 512, and 514. At least some of menu elements, before being displayed on the display screen 408, can be received by the electronic device 402 from the server 420.

The menu element can be data for inclusion into a browser contextual assistant. The data for inclusion into a browser contextual assistant provides a user with relevant information. In FIG. 5, browser contextual assistant 502 comprises the data 508 for inclusion into a browser contextual assistant 502.

The data for inclusion into a browser contextual assistant 502 can be selected by the server 420 from a plurality of data being suitable for inclusion into a browser contextual assistant 502.

Further, the menu element can be a menu item. The menu item allows to a user 440 performing an action.

The menu item can be context-sensitive menu item and non-context-sensitive menu item.

The context-sensitive menu items can be selected by the server 420 from a plurality of menu items and data being suitable for inclusion into a browser contextual assistant 502. For example, there can be predetermined list of context-sensitive menu items, the list of context-sensitive menu items accessible by the contextual assistance module 432. Non-limiting examples of the context-sensitive menu items can be menu items: “biography”, “more in the news”, “get direction”, “auto-fill”, “listen to”, “download from”, “share on [social network name]”, “convert the unit”, “exchange rate”, “translate the word/sentence”, “product review”, “press-portrait”, “go to”, “show the music collection”, and so on. Context-sensitive menu items in the list of menu items can be linked to specific types of user queries. For instance, one or both commands “Show the address on the map” and “Get direction” can be related to queries identified as addresses, dependant on whether server 420 possess geo location data of the electronic device 402. The menu item “Go to” can be related to queries where the user 440 selects a simple text, not a hyperlink, where the search shows that the selected text is identical to an URL. General and vertical searches allow determining of the search type by analysing results returned by web search module 428 and vertical search module 430.

The non-context-sensitive menu item can be selected by the server 420 for inclusion into the browser contextual assistant 502. The non-context-sensitive menu items, which are non-context-sensitive menu items 514 and 516 in this example, do not depend on the semantic meaning of the user-selected information, which is phrase 504 “Red Square” in this example. Non-limiting examples of the non-context-sensitive menu items can be menu items: “copy”, “paste”, “search on [name of the search engine]”, “print”, “open link in new window”, “copy image”, “set as background”. Even if menu item “copy image” will appear only when an image is selected, this menu item is non-context-sensitive, because it based on file properties (image file), and not on who or what is depicted on the image.

The browser contextual assistant 502 depicted on FIG. 5 comprises five menu elements: the context-sensitive menu item 510, another context-sensitive menu item 512, the non-context-sensitive menu item 514, and another non-context-sensitive menu item 516.

In some implementations, the menu elements can be ranked within the browser contextual assistant. As it is shown on FIG. 5, the menu elements are ranked by category: the data 508 for inclusion into browser contextual assistant is placed on the top; all context-sensitive menu items 510 and 512 are placed in the middle of the browser contextual assistant 502, following the data 508 for inclusion into browser contextual assistant; and then all non-context-sensitive menu items 514 and 516 are placed in the bottom of the browser contextual assistant 502, following two context-sensitive menu items 510 and 512. In alternative embodiments, menu elements can be ranked based on other criteria, such as relevancy of the menu elements. In yet alternative embodiments, data 508 for inclusion into browser contextual assistant can always come first (or always come last, or always come second, etc.) In yet alternative embodiments, menu elements can also be not ranked.

Generally speaking, the number of items containing data for inclusion into a browser contextual assistant can be limited by the maximum number of menu elements physically placeable into browser contextual assistant 502. The maximum number of menu elements can be preprogrammed. The maximum number of menu elements can depend on type of the electronic device 402, and on certain characteristics of the electronic device 402, such as resolution of the display screen 408, type installed web browser, and others. The inverse relation can exist between the number of items containing data for inclusion into a browser contextual assistant and number of menu items for inclusion into a browser contextual assistant: as much space is provided for placement of menu items, as less space is provided for placement items containing data for inclusion into a browser contextual assistant, and vice versa. The relation is not necessarily linear: size of each particular menu element can be taken into account. For example, if data for inclusion into a browser contextual assistant is twice large in space than the menu item, and if maximum number of menu elements is 4, the following combinations are possible:
four menu items;
one item containing data for inclusion into a browser contextual assistant, and two menu items;
two items containing data for inclusion into a browser contextual assistant.

The browser contextual assistant 502 depicted on FIG. 5 comprises five menu elements. However, the maximum number of menu elements in the implementation depicted on FIG. 5 is six menu elements. The reason why the number of displayed menu elements do not reach the maximum number of menu elements is that the data 508 for inclusion into a browser contextual assistant 502 takes twice the space as each of menu items 510, 512, 514, and 516. Inclusion the sixth menu element is not possible due do lack of space in the browser contextual assistant 502.

In other implementations, the browser contextual assistant 502 can comprise fewer than five menu elements or more than five menu elements, but always fewer than the maximum number of menu elements.

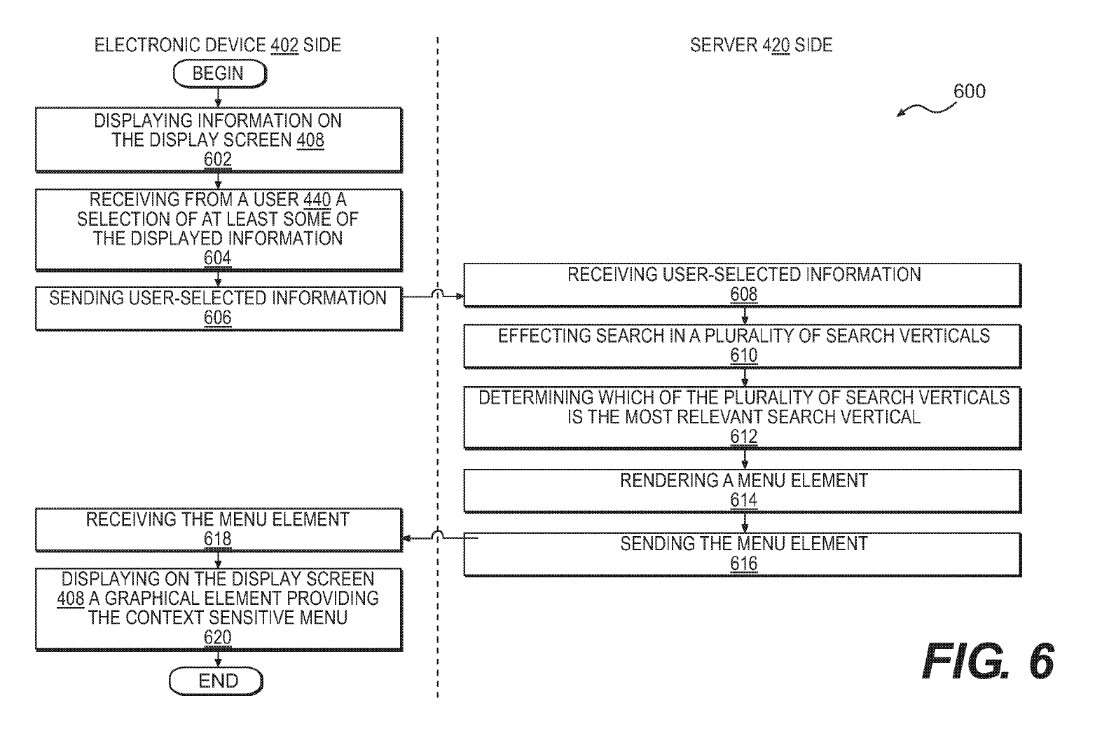

Referring to FIG. 6, there is shown a block diagram depicting a method 600, the method 600 being implemented within the system 400 of FIG. 4 and being implemented according to non-limiting embodiments of the present technology.

In brief, the method 600 describes implementations of the present technology, where web content, such a web page, is displayed on the display screen 408 of the electronic device 402. The user 440 wants to get more information or perform an action with a portion of the web content, such as a word, or a phrase, or a sentence, or an image. The user 440 selects a text, or image, or both, presently displayed in a web browser on the display screen 408. Once the portion of the web content is selected by the user 440, the electronic device transmits the user-selected information to the server 420. The server 420 receives the user selected information from the electronic device 402. In some embodiments, the electronic device 402 along with the user selected information can further transmit information other than the user-selected information, such as a user ID that identifies either the user 440 himself or the electronic device 402, or both. The server 420 treats the information received from the electronic device 402 as a search query. The server 420 performs the web search as though the user selected information were the search query entered into a search bar of a web browser. The server 420 effects the general web search and the search in verticals. Then, the server 420 determines which of pluralities of search verticals is relevant search vertical. Then, based on predetermined criteria, the server renders a menu element, which menu element is related to the search result. For example, if the user selected information, being a text, is recognized as an address, the related menu element can be “Show on the map”. Then, the server 420 transmits the menu element to the electronic device 402, and the electronic device 402 receives and displays the menu element within the contextual browser assistant. It should be mentioned, that the server 420 can produce more than one menu element. Therefore, more than one menu element will be rendered and sent by the server 420 to the electronic device 402, and more than one menu element will be displayed into the browser contextual assistant. In more details, the method 600 is described below.

The method 600 is a computer-implemented method of providing a browser contextual assistant 502 in a graphical user interface on a display screen 408 of an electronic device 402, the electronic device 402 having a user input device 404, a computer usable information storage medium 406, and a processor 410 coupled to the display screen 408, to the user input device 404, and to the computer usable information storage medium 406, the processor 410 being configured to have access to computer readable commands.

The method 600 starts at step 602, where the electronic device 402 displays information in the graphical user interface on the display screen 408. The information displayed in the graphical user interface on the display screen 408 of the electronic device 402 can be a web page, as it is shown on FIG. 5. The user 440 may need additional information with regard to a part of the information displayed on the display screen 408 of the electronic device 402, or user 440 may need to perform an action with regard to a part of the information displayed on the display screen 408 of the electronic device 402. To that end, the user 440 can select at least some of the displayed information.

At step 604, the electronic device 402 receives from a user 440 of the electronic device 402 via the user input device 404 a selection of at least some of the displayed information. The selection can be a text, or image, or both, presently displayed in a web browser on the display screen 408.

It is not particularly important how the user 440 selects the information. In some implementations, the user 440 can select the information by selection a text, or image, or both, with a pointing device like a mouse. In some implementations, the user 440 can double-click on a word or on an image. In some implementations, the user 440 can right-click on a word or on an image. In some implementations, the user 440 can select the information by selection a text, or image, or both, with his or her finger on a touch screen display. Other selection methods are also possible.

At step 606, the electronic device 402 sends to a server 420 via the communications network 412 user-selected information. In some implementations, sending by the electronic device 402 to a server 420 the user-selected information includes sending information other than the user-selected information, such as textual elements and/or graphical elements in proximity to the user-selected information in the graphical user interface. In some implementations, sending by the electronic device 402 to a server 420 the user-selected information includes, additionally or alternatively, sending characteristic of the electronic device 402 and/or a location of the electronic device 402.

At step 608, the server 420 receives via the communications network 412 from the electronic device 402 the user-selected information.

At step 610, the server 420 effects a general web search and a search in a plurality of search verticals in respect of the user-selected information.

How the server 420 effects a search in a plurality of search verticals in respect of the user-selected information is generally known in the art.

At step 612, the server 420 determines which of the plurality of search verticals is the most relevant search vertical. How the server 420 determines which of the plurality of search verticals is the most relevant search vertical is generally known in the art. However, briefly, after the server 420 transmits the user-selected information to the search cluster 424, the processing module 426 of the search cluster 424 communicates with the web search module 428 and the vertical search module 430 to determine a plurality of web resources that are relevant (i.e. responsive) to the user-selected information. As a person skilled in the art will understand, in some implementations, the processing module 426 may communicate exclusively with the web search module 428, and not with the vertical search module 430, and vice versa. In other implementations, there can be more than one vertical search modules similar to the vertical search module 430. For example, these other vertical search modules may include: a video vertical search module, a maps vertical search module, a news vertical search module and the like. For example, if the user 440 selects words “Van Gogh” on the web page actually displayed on the display screen 408, the most relevant resources can be images and general web content.

At step 614, the server 420 renders at least one menu element. The menu element can be a menu item. The menu element can also be data for inclusion into the browser contextual assistant 502. The menu element is selected by the server 420 from a plurality of menu items and data being suitable for inclusion into a browser contextual assistant. Menu items can be context-sensitive menu items and non-context-sensitive menu items.

Notably, the data for inclusion into the browser contextual assistant 502 can be selected by the server 420 from a plurality of data being suitable for inclusion into a browser contextual assistant. The data being suitable for inclusion into a browser contextual assistant can be generated by the contextual assistant module 432 based on results of the general web search and/or vertical web search(es). For example, as a result of the search using selected by the user 440 words “Red Square”, the general web search determines that Wikipedia's article “Red Square” is relevant. Based on that result, contextual assistant module 432 can generate data 508 for inclusion into a browser contextual assistant 502 (which data can be a snippet), as it is shown on FIG. 5.

The context-sensitive menu items can be selected by the server 420 from a plurality of menu items and data being suitable for inclusion into a browser contextual assistant. For example, there can be predetermined list of context-sensitive menu items, the list of context-sensitive menu items accessible by the contextual assistance module 432. Non-limiting examples of the context-sensitive menu items can be menu items: “biography”, “more in the news”, “get direction”, “auto-fill”, “convert the unit”, “exchange rate”, “translate the word/sentence”, “product review”, “press-portrait”, “go to”, “show the music collection”, and so on. Context-sensitive menu items in the list of menu items can be linked to specific types of user queries. For instance, one or both commands “Show the address on the map” and “Get direction” can be related to queries identified as addresses, dependant on whether server 420 possess geo location data of the electronic device 402. As another example, the menu item “Go to” can be related to queries where the user 440 selects a simple text being not a hyperlink, where the search shows that the selected text is identical to an URL. For more clarity, the user 440 selects a text “massachusetts.edu”. Despite the fact that the text “massachusetts.edu” is written as a hyperlink, this is not a hyperlink, this is a plain text. The electronic device 402 transmits the selected text “massachusetts.edu” to the server 420. The server 420 performs the search, results of the search demonstrate that the text “massachusetts.edu” contains in the valid URL http://www.massachusetts.edu/, and the title of the main page of that web site is “University of Massachusetts System—UMass Home”. Therefore, the server can determine that the menu item “Go to University of Massachusetts System—UMass Home” is related to the user-selected information, and add that menu item into browser contextual assistant 502. Generally speaking, general and vertical searches allow determining of the search type by analysing results returned by web search module 428 and vertical search module 430.

As yet another example of selection process, the server 420 receives as user-selected information, from the electronic device 402, words “UFO was seen by American astronauts today”. Lets assume that the fact that UFO was seen by American astronauts was recently reported by many on-line magazines and news agencies. Based on vertical searches and general web search performed, the server 420 can determine that the most relevant search results are the searches performed by news vertical search. Therefore, the server 420 can render a menu element based on high relevancy of news search vertical. The menu element in this case can be a small widget containing the title of the most relevant article returned by the news search vertical, and hyperlink to the publishing source. The menu element, namely the widget containing the text and hyperlink, is data for inclusion into a browser contextual assistant. In this example, data for inclusion into a browser contextual assistant is the data which is related to the most relevant search vertical.

As yet another example of selection process, the server 420 receives as user-selected information, from the electronic device 402, the word “Armstrong”. Based on vertical searches and general web search performed, the server 420 can determine that the most relevant search results are rendered by general web search. More particularly, the general web search can determine that Wikipedia's article “Neil Armstrong” is highly relevant to the search query containing the word “Armstrong”. Therefore, the server 420 can render a menu element based on high relevancy of general web search vertical. The menu element in this case can be a small widget containing the title of the most relevant on-line encyclopedia article or the most relevant on-line dictionary article, and hyperlink to the publishing source. The menu element, namely the widget containing the text and hyperlink, is data for inclusion into a browser contextual assistant. In this example, data for inclusion into a browser contextual assistant is the data which is related to the highly relevant general web search result.

The non-context-sensitive menu item can be selected by the server 420 for inclusion into the browser contextual assistant 502. Non-limiting examples of the non-context-sensitive menu items can be menu items: “copy”, “paste”, “search on [name of the search engine]”, “print”, “open link in new window”, “copy image”, “set as background”. Even if menu item “copy image” will appear only when an image is selected, this menu item is non-context-sensitive, because it based on file properties (image file), and not on who or what is depicted on the image.

The server 420 renders the menu element for displaying by the electronic device 402 in the graphical user interface on the display screen 408. The menu element is related to the user-selected information, wherein the at least one of the menu item and the data being related to the most relevant search vertical.

In some implementations, the server 420 can render more than one menu element. These menu elements can comprise menu items, data for inclusion into a browser contextual assistant, or both.

Then, at step 616, the server 420 sends to the electronic device 402 via the communications network 412 in any suitable format, for example in JSON format, the menu element.

In some implementations, the server 420 can send more than one menu element. These menu elements can comprise menu items, data for inclusion into a browser contextual assistant, or both.

In some implementations, the server 420 also can send one or more non-context-sensitive menu elements for inclusion into the browser contextual assistant, in addition to at least one context-sensitive menu element.

At step 618, the electronic device 402 receives from the server 420 via the communications network 412 the menu element.

In some implementations, the electronic device 402 can receive more than one menu element. These menu elements can comprise menu items, data for inclusion into a browser contextual assistant, or both.

In some implementations, the electronic device 402 also can receive a non-context-sensitive menu element for inclusion into the browser contextual assistant. Alternatively, the electronic device 402 can generate a non-context-sensitive menu element and insert this non-context-sensitive menu element into the browser contextual assistant.

In some implementations, the menu elements can be ranked. For example, context-sensitive menu elements can be ranked according their relevancy to the user-selected information, wherein menu elements are put into browser contextual assistant in the descendant order, the most relevant context-sensitive menu elements placed on the top; further, the non-context-sensitive menu elements are put in the bottom of the browser contextual assistant. Another example is shown on FIG. 5, where the menu elements are ranked by category: the data 508 for inclusion into browser contextual assistant is placed on the top; all context-sensitive menu items 510 and 512 are placed in the middle of the browser contextual assistant 502, following the data 508 for inclusion into browser contextual assistant; and then all non-context-sensitive menu items 514 and 516 are placed in the bottom of the browser contextual assistant 502, following two context-sensitive menu items 510 and 512.

At step 620, the electronic device 402 displays on the display screen 408 a graphical element providing the browser contextual assistant 502, as it is shown on FIG. 5. The browser contextual assistant 502 can comprise menu items, data for inclusion into a browser contextual assistant, or both.

Then, the method 600 terminates.

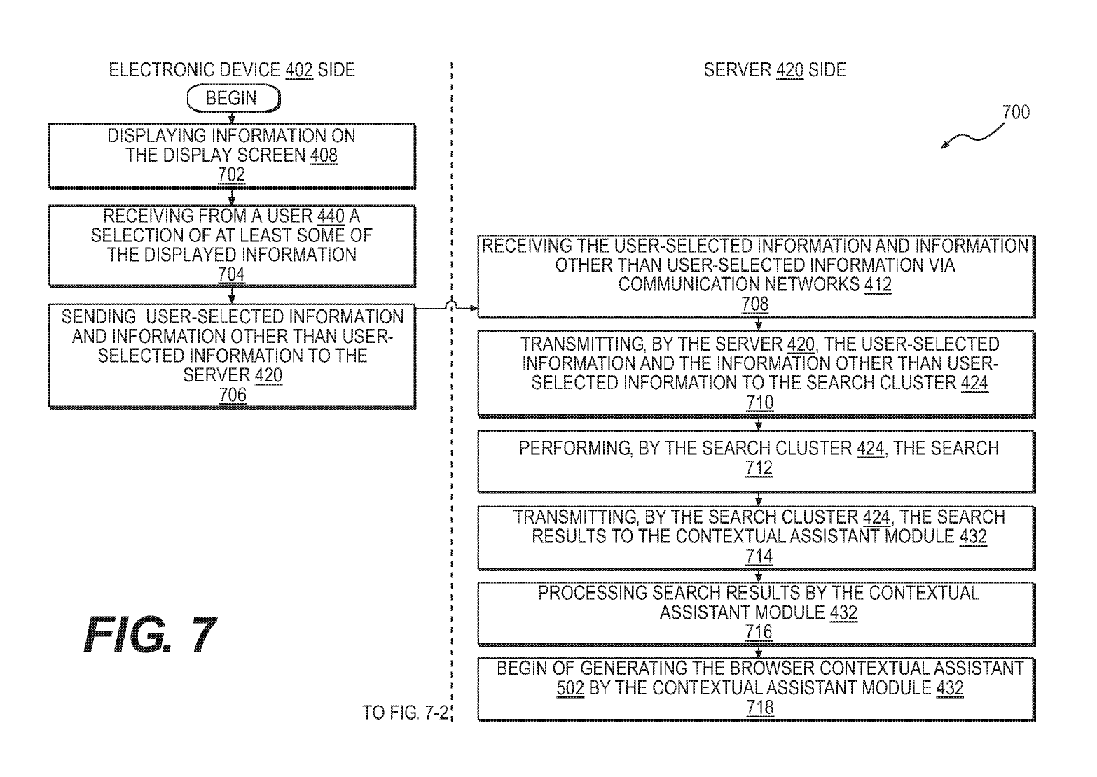

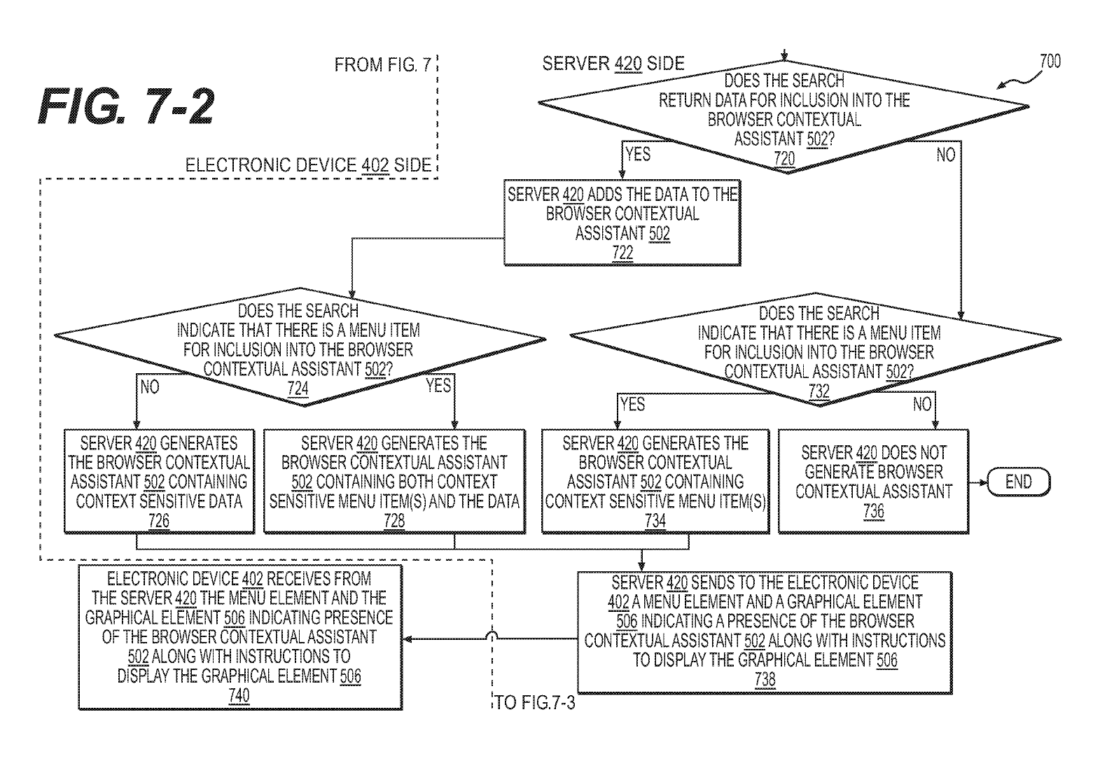

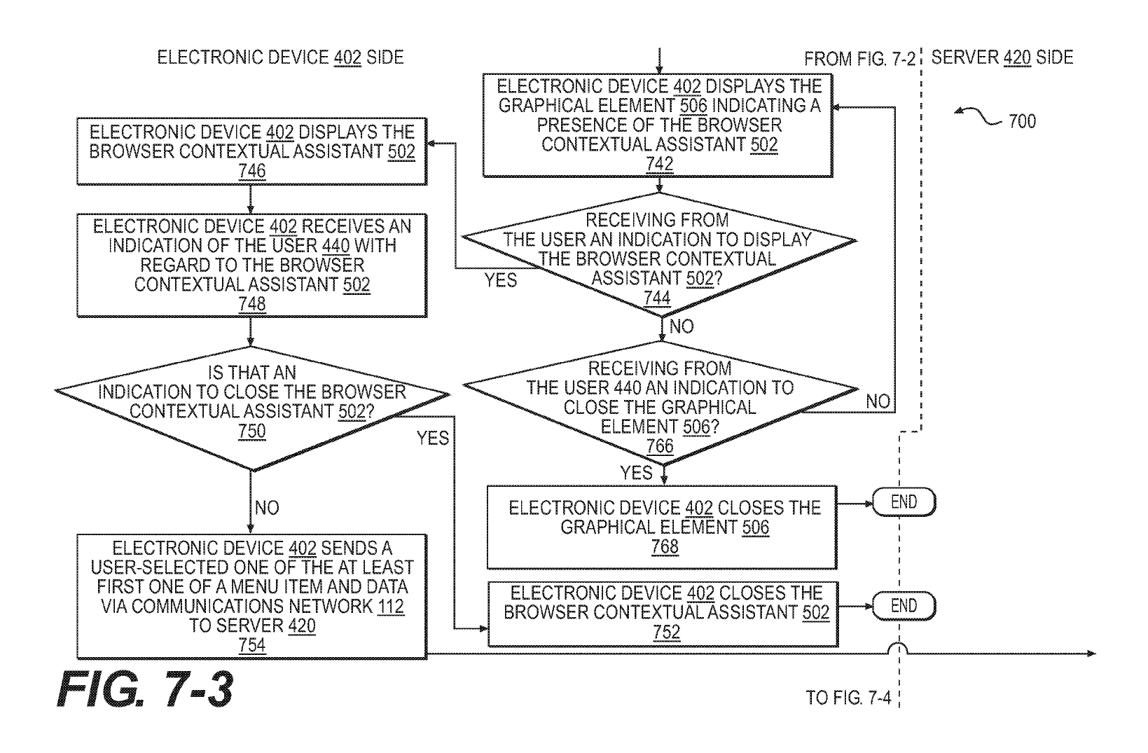

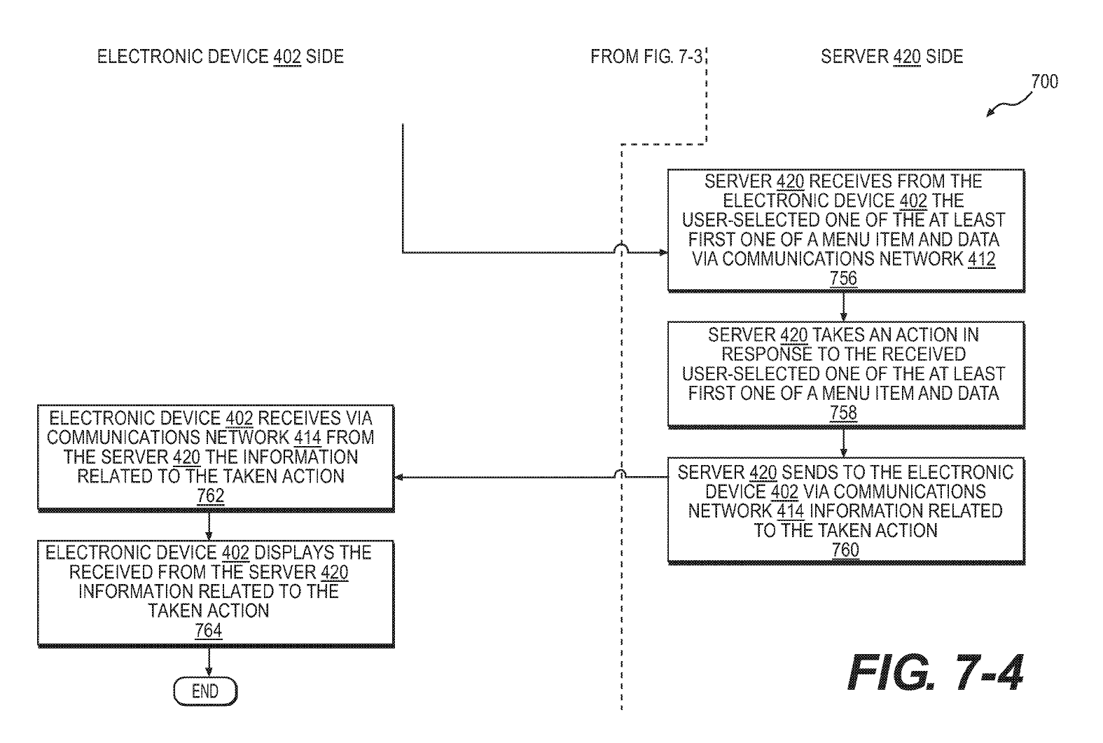

FIG. 7 is a block diagram depicting a method 700, the method 700 being implemented within the system 400 of FIG. 4 and being implemented according with other non-limiting embodiments of the present technology.

The method 700 is an alternative computer-implemented method for providing a browser contextual assistant 502 in a graphical user interface on a display screen 408 of an electronic device 402, the electronic device 402 having a user input device 404, a computer usable information storage medium 406, and a processor 410 coupled to the display screen 408, to the user input device 404, and to the computer usable information storage medium 406, the processor 410 being configured to have access to computer readable commands.

The method 700 starts at step 702, where the electronic device 402 displays information in a graphical user interface on the display screen 408. The information displayed in a graphical user interface on the display screen 408 of the electronic device 402 can be a web page, as it is shown on FIG. 5. The user 440 may need more information with regard to a part of the information displayed on the display screen 408 of the electronic device 402. To that end, the user 440 can select at least some of the displayed information.

At step 704, the electronic device 402 receives from the user 440 of the electronic device 402 via the user input device 404 a selection of at least some of the displayed information. The selection can be a text, or image, or both, presently displayed in a web browser on the display screen 408.

It is not particularly important how the user 440 selects the information. In some implementations, the user 440 can select the information by selection a text, or image, or both, with a pointing device like a mouse. In some implementations, the user 440 can double-click on a word or on an image. In some implementations, the user 440 can right-click on a word or on an image. In some implementations, the user 440 can select the information by selection a text, or image, or both, with his or her finger on a touch screen display. Other selection methods are also possible.

At step 706, the electronic device 402 sends to a server 420 via communications network 412 user-selected information and information other than the user-selected information. The other than the user-selected information can comprise textual elements and/or graphical elements in proximity to the user-selected information in the graphical user interface, characteristic of the electronic device 402 and/or a location of the electronic device 402.

At step 708, the server 420 receives via the communications network 412 from the electronic device 402 the user-selected information and information other than the user-selected information. The information other than the user-selected information can comprise textual elements and/or graphical elements in proximity to the user-selected information in the graphical user interface, characteristic of the electronic device 402 and/or a location of the electronic device 402.

At step 710, the server 420 transmits the user-selected information and the information other than the user-selected information to the search cluster 424.

At step 712, the search cluster 424 performs a search in plurality of search verticals in respect of the user-selected information and information other than the user-selected information, wherein the general web search is considered to be one of verticals.

How the server 420 effects a search in a plurality of search verticals in respect of the user-selected information is generally known in the art.

At step 714, the search cluster 424 transmits search results to the contextual assistant module 432. Then, at step 716, the contextual assistant module 432 processes all results of search. The contextual assistant module 432 determines which of the plurality of search verticals are most relevant search verticals. When determining the relevance of search verticals, the result of general web search is treated as one of verticals.

Based on results of search, at step 718, the server 420 starts generating menu elements, wherein at least one menu element rendered by the server 420 shall be based on the relevancy of search verticals. In other words, at least one menu element shall be context sensitive

The menu element can be a menu item. The menu item allows to a user 440 performing an action.

The menu element also can be data for inclusion into a browser contextual assistant. The data for inclusion into a browser contextual assistant provides a user with relevant information.

In some implementations, the server 420 can render more than one menu element. These menu elements can comprise menu items, data for inclusion into a browser contextual assistant, or both.

Some menu elements can be selected by the server 420 from plurality of menu items and data being suitable for inclusion into a browser contextual assistant. For example, there can be predetermined list of menu items, the list of menu items accessible by the contextual assistance module 432. Menu items in the list of menu items can be linked to specific types of user queries. For instance, one or both commands “Show the address on the map” and “Get direction” can be related to queries identified as addresses or place, dependant on whether server 420 possess geo location data of the electronic device 402. General and vertical searches allow determining of the search type by analysing results returned by web search module 428 and vertical search module 430.

The server 420 renders one or more menu elements for displaying by the electronic device in the graphical user interface. At least one menu element is related to the user-selected information. The menu element, related to the user-selected information, is context sensitive due to the fact that the menu element was selected by the server 420 after general web search and vertical searches were completed, and the choice of the menu element was made based on results of the general web search and vertical web searches.

As an illustrative example of selection process, the server 420 receives from the electronic device 402, as user-selected information, an address. In addition, the server 420 receives from the electronic device 402, as information other than the user-selected information, geo location data of the electronic device 402. Based on vertical searches and general web search performed, the server 420 can determine that most relevant search results are results from the map service. Based on logs, the server 420 can determine that there are two actions frequently requested after similar searches, and these two actions are displaying the address on the map and creating itinerary from the starting point where the electronic device 402 is physically located to the address selected by the user 440. Therefore, the server can render two menu elements based on the relevancy of search verticals: “Show the address on the map”, and “Get direction”. Both menu elements in this example are menu items.

As another illustrative example of selection process, the server 420 receives as user-selected information, from the electronic device 402, words “Red Square”. In addition, the server 420 receives from the electronic device 402, as information other than the user-selected information, geo location data of the electronic device 402, geo location data that the electronic device 402 at the request time is physically located in Moscow, Russia. Based on vertical searches and general web search performed, the server 420 can determine that the most relevant search results are the searches performed by map services and by general web search. More particularly, the general web search determines that Wikipedia's article “Red Square” is relevant. Based on frequency analysis, the server 420 also can determine that there are two actions frequently requested after similar searches, namely “Show the address on the map” and “Get direction”, that is these are two actions are displaying the address on the map and creating itinerary from the starting point where the electronic device 402 is physically located to the address selected by the user 440 (the result could be different if the electronic device 402 would be located in Montreal, Canada; in this case, the menu item “Get direction” would be not relevant, and geo location data of the electronic device 402 would be used as a filter). Therefore, the server can render three menu elements based on the relevancy of search verticals, wherein general web search is considered to be one of verticals. Two menu elements, namely “Show the address on the map” and “Get direction”, are menu items. The third menu element, namely short info with regard to historic place Red Square, is data for inclusion into a browser contextual assistant. In this example, all the menu items and the data are related to the most relevant search verticals.

As another example, the server 420 receives as user-selected information, from the electronic device 402, words “Red Square”. In addition, the server 420 receives from the electronic device 402, as information other than the user-selected information that the information that the user 440 is logged on a social network Facebook. In this case, the server 420 can additionally choose another menu element, namely “Share the selection on Facebook”.

As yet another example of selection process, the server 420 receives as user-selected information, from the electronic device 402, the word “Armstrong”. In addition, the server 420 receives from the electronic device 402, as information other than the user-selected information, the text immediately preceding and following the user selection, and the text preceding the word “Armstrong” contains the word “Louis”. Based on vertical searches and general web search performed, the server 420 can determine that the most relevant search results are rendered by general web search. More particularly, the general web search can determine that Wikipedia's article “Louis Armstrong” is highly relevant to the search query containing both words “Louis” and “Armstrong”, and not Neil Armstrong as it would be the case if the search would be performed based on word “Armstrong” only. Therefore, the server 420 can render a menu element based on high relevancy of general web search vertical. The menu element in this case can be a small widget containing the title of the most relevant on-line encyclopedia article or the most relevant on-line dictionary article, and hyperlink to the publishing source. The menu element, namely the widget containing the text and hyperlink, is data for inclusion into a browser contextual assistant. In this example, data for inclusion into a browser contextual assistant is the data which is related to the highly relevant general web search result.

At step 720, the server 420 determines whether the search returned the data for inclusion into a browser contextual assistant.

As it follows from the description below, the method 700, after the step 720, can follow four scenarios, each of scenarios resulting in respectively the step 726 (server 420 generates menu comprising the data for inclusion into menu), the step 728 (server 420 generates menu comprising both the menu item and the data for inclusion into menu), the step 734 (server 420 generates menu comprising a menu item), the step 736 (server 420 generates neither menu item nor a data for inclusion into menu; therefore, no browser contextual assistant is generated which results in the end of method).

Now, all these scenarios will be described in more details.

If, at the step 720, the determination is positive, the method 700 proceeds to the step 722. If the determination is negative, the method 700 proceeds to step 730.

For illustrative purposes, we assume that the determination in the step 720 is positive, and the method 700 proceeds therefore to the step 722.

At step 722, the server 420 adds to the menu the relevant data for inclusion into the browser contextual assistant 502. The server can include into menu one or more items containing data for inclusion into a browser contextual assistant.

Then, at step 724, the server 420 determines whether the search returned the menu items for inclusion into a browser contextual assistant 502. If the determination is positive, the method 700 proceeds to the step 728. If the determination is negative, the method 700 proceeds to step 726.

We assume that the determination in the step 724 is negative, the method 700 proceeds therefore to the step 726.

Since the search returned data for inclusion into the menu (see description above, steps 720 to 722), and since the search returned no menu items, the server 420, at step 726, generates the menu containing data for inclusion into the menu (for example, brief info about the Red Square), but no menu items. Then, the method proceeds to the step 738.

If, on the other hand, the determination in the step 724 is positive, the server 420 determines that there are menu items related to the search results. Therefore, the method 700 proceeds to the step 728.

Since the search returned data for inclusion into the menu (see description above, steps 720 to 722), and since the search returned menu items, the server 420, at step 728, generates the menu containing both data for inclusion into the menu (for example, brief info about the Red Square, as it is depicted on FIG. 5 under #508), and one or more menu items (for example, the context-sensitive menu item 510 “Get direction to the Red Square” and the context-sensitive menu item 512 “Show the red Square on the map”, as it is depicted on the FIG. 5.) Then, the method proceeds to the step 738.

Now, returning back to the step 720, we assume that the determination in the step 720 is negative. Since the determination in the step 720 is negative, the server 420 does not add to the menu any “data for inclusion into the menu” because the search returned no data for inclusion into a browser contextual assistant, and we proceed to the step 732.

At step 732, the server 420 determines whether the search returned the menu items for inclusion into a browser contextual assistant. If the determination is positive, the method 700 proceeds to the step 734. If the determination is negative, the method 700 proceeds to step 736.

We assume that the determination in the step 732 is positive, and there is one or more menu items related to the search results. Therefore, the method 700 proceeds to the step 734.

Since the search returned no data for inclusion into the menu (see description above, steps 720 to 722), and since the search returned menu items, the server 420, at step 734, generates one or more menu items only, and no data for inclusion into the menu. Then, the method proceeds to the step 738.

Now, returning back to the step 732, we assume now that the determination in the step 732 is negative, the method 700 proceeds therefore to the step 736.

Since the search returned no data for inclusion into the menu (see description above, steps 720 to 722), and since the search returned no menu items, the server 420, at step 726, does not generate browser contextual assistant. In this case, the method then terminates.

Now, after anyone of steps 726, 728, and 734, the method 700 proceeds to step 738.

At step 738, the server 420 sends to the electronic device 402 a graphical element indicating a presence of the browser contextual assistant (such as depicted under #505 on FIG. 5) along with menu elements (for example, such as depicted under #508, #510, #512, #514, #516 on the FIG. 5) for inclusion into browser contextual assistant 502.

In alternative embodiments, the server 420 can send to the electronic device 402 menu elements for immediate displaying, and not the graphical element indicating a presence of the browser contextual assistant. In yet alternative embodiments, the server 420 can send to the electronic device 402 a graphical element indicating a presence of the browser contextual assistant, and not menu elements.

At step 740, the electronic device 402 receives from the server 420 via the communications network 412 graphical element indicating a presence of the browser contextual assistant along with menu elements for inclusion into browser contextual assistant. However, the electronic device 402 does not display immediately the browser contextual assistant 502 comprising received menu elements. The electronic device further receives from the server 420 instructions how to assembly and to display the menu. More precisely, the electronic device 402 receives instructions how to rank the menu elements and/or data within the browser contextual assistant 502.

In other embodiments, the server 420 may not send instructions how to make the browser contextual assistant 502. In those implementations, the browser contextual assistant 502 can be created on the electronic device 402 side from menu elements received from the server 420.

In alternative embodiments, the electronic device 402 can receive from the server 420 via the communications network 412 menu elements for immediate displaying, and not the graphical element indicating a presence of the browser contextual assistant. In yet alternative embodiments, the electronic device 402 can receive from the server 420 via the communications network 412 a graphical element indicating a presence of the browser contextual assistant, and not menu elements.

At step 742, the electronic device 402 displays the graphical element 506 indicating the presence of the browser contextual assistant 502 received from the server 420, and does not display the browser contextual assistant 502 itself.

In alternative embodiments, the electronic device 402 can immediately display the browser contextual assistant 502 comprising menu elements.

At step 744, the electronic device 402 determines whether the user 440 makes indication to display the browser contextual assistant 502.

In the cases where the electronic device 402 at step 744 does not receive from the user 440 the indication to display the browser contextual assistant on the display screen 408, the method 700 proceeds to step 766, where the electronic device 402 determines whether the user 440 makes indication to close the graphical element 506. In the cases where the electronic device 402 at step 766 does not receive from the user 440 the indication to close the graphical element 506, the electronic device 402 continues waiting, which is shown on the FIG. 7 as retour to the step 742. In the cases where the electronic device 402 at step 766 receives from the user 440 the indication to close the graphical element 506, the electronic device 402, at step 768, closes the graphical element 506. Then, the method 700 terminates.

In the cases where the electronic device 402, at step 744, receives from the user 440 the indication to display the browser contextual assistant on the display screen 408, the method 700 proceeds to the step 746.

At step 746, the electronic device 402 displays the browser contextual assistant 502 on the display screen 408.

At step 748, the electronic device 402 receives an indication from the user 440 with regard to the browser contextual assistant 502. Generally speaking, there can be two types of indication. The first one is to close the browser contextual assistant without performing any further action with regard to the browser contextual assistant, which will be ultimately result in step 752. The second option is to take an action supported by the browser contextual assistant, such as follow the hyperlink or to click the menu item in the browser contextual assistant, which will result in steps 754 and following.

At step 750, the electronic device 402 determines whether the indication of the user 440 is indication to close the browser contextual assistant without performing any further action with regard to the browser contextual assistant, or is it a choice from the browser contextual assistant.

There are several examples of possible behaviour of the user 440. Once the browser contextual assistant is displayed on the display screen 408, the user 440 has several options. The user 440 may decide that all the menu elements are of no interest for him or her, and consequentially may decide to close the browser contextual assistant. The user 440 may consult the data included into the browser contextual assistant, and consequentially may decide to close the browser contextual assistant, because the data was sufficient and no additional information is needed. In these examples, the user 440 may indicate his or her intent to close the browser contextual assistant in any conventional manner. For example, the user 440 may indicate his or her intent to close the browser contextual assistant by clicking with a pointer device on the display screen 408 in any area outside of the browser contextual assistant. The electronic device 402 can determine such an indication as indication to close the browser contextual assistant without performing any further action with regard to the browser contextual assistant. Consequentially, the method 700 proceeds to the step 752 where the electronic device 402 closes the browser contextual assistant and does not execute any other action with regard to the browser contextual assistant. Then, the method 700 terminates.

Returning back to the step 750, the user 440 has further options, such as the user 440 may consult the data included into the browser contextual assistant, and consequentially may decide to follow the hyperlink containing in the browser contextual assistant. Yet another option is that the user 440 may click on menu item in the browser contextual assistant. The electronic device 402 will determine such an indication as indication to close the browser contextual assistant and to performing a further action with regard to the browser contextual assistant. Consequentially, the method 700 will proceed to the step 754.

At step 754, the electronic device 402 sends to the server 420 via the communications network 412 a user-selected one of the menu item and a user-selected data, wherein the user-selected data is a hyperlink containing in the data for displayed in the content-sensitive menu.

At step 756, the server 420 receives from the electronic device 402 via the communications network 412 a user-selected one of the menu item and a user-selected data, wherein the user-selected data comprises a hyperlink.

At step 758, the server 420 takes an action in response to the received a user-selected one of the menu item and a user-selected data, wherein the user-selected data is a hyperlink containing in the data 508. The action performed by the server 420 depends on the user-selected menu item or user-selected data. For example, if the user 440 clicks on the context-sensitive menu item 510 “Get direction to the Red Square”, the server 420 creates itinerary from the point of location of the electronic device 402 to the Red Square in Moscow, the destination selected by the user 440. If the user 440 clicks on a hyperlink comprising in the data 508, the server 420 retrieves the Wikipedia web page for the Red Square, that is the web source corresponding to the hyperlink in the data 508.

At step 760, the server 420 sends to the electronic device 402 via the communications network 412 information related to the taken action. For example, if the user 440 clicks on the menu item “Get direction” and the server 420 creates itinerary from the point of location of the electronic device 402 to the destination selected by the user 440, the information related to the taken action is the itinerary from the point of location of the electronic device 402 to the destination selected by the user 440. As another example, if the user 440 clicks on a hyperlink comprising in the data, and the server 420 retrieves a web source corresponding to the hyperlink, the information related to the taken action is the web source corresponding to the hyperlink.

At step 762, the electronic device 402 receives from the server 420 via where the electronic device 402 at step via the communications network 412 information related to the taken action. For example, if the user 440 clicks on the menu item “Get direction” and the server 420 creates itinerary from the point of location of the electronic device 402 to the destination selected by the user 440, the information related to the taken action is the itinerary from the point of location of the electronic device 402 to the destination selected by the user 440. As another example, if the user 440 clicks on a hyperlink comprising in the data, and the server 420 retrieves a web source corresponding to the hyperlink, the information related to the taken action is the web source corresponding to the hyperlink.

At step 764, the electronic device 402 displays on the display screen 408 the information received from the server 420. The method 700 then terminates.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A computer-implemented method for providing a graphical element providing a browser contextual assistant in a graphical user interface on a display screen of an electronic device, the electronic device having a user input device, a computer usable information storage medium, and a processor coupled to the display screen, to the user input device, and to the computer usable information storage medium, the processor being configured to have access to computer readable commands, the method comprising:
(I) receiving, by a server from the electronic device via a communications network, user-selected information appearing in the graphical user interface the user-selected information appearing in the graphical user interface being part of a web page content displayed on the display screen;
(II) effecting, by the server, a search in a plurality of search verticals in respect of the user-selected information to render a plurality of search results;
(III) based on an analysis of the plurality of search results, determining, by the server, which of the plurality of search verticals is the most relevant search vertical and determining a query type associated with the user-selected text;
(IV) rendering a menu element, the menu element selected from (a) one or more menu items and (b) data for inclusion into the browser contextual assistant the menu element to be displayed by the electronic device in the graphical user interface in respect of the user-selected information, the menu element having been selected by the server by executing:
selecting, from a list of menu items, the one or more menu items, the one or more menu items having been pre-determined for a given query type of the plurality of query types, the one or more menu items indicating one or more actions to be performed with the user-selected information,
selecting data for inclusion into the browser contextual assistant based on the plurality of search results;
(V) sending, by the server to the electronic device via the communications network, the menu element, the menu element for concurrent displaying with and in association with the user-selected information appearing in the graphical user interface.

2. The computer-implemented method of claim 1, wherein
rendering the menu element is rendering plurality of menu elements, the at least two menu elements being related to at least one most relevant search vertical, and
sending, by the server to the electronic device via the communications network, the menu element is sending plurality of menu elements.

3. The computer-implemented method of claim 1, further comprising sending a non-context-sensitive menu element for inclusion into the browser contextual assistant.

4. The computer-implemented method of claim 1, wherein the menu elements are ranked.

5. The computer-implemented method of claim 1, further comprising
receiving, by the server from the electronic device via the communications network, information other than the user-selected information; and
effecting, by the server, the search in the plurality of search verticals in respect of the user-selected information and at least some of the information other than the user-selected information.

6. The computer-implemented method of claim 5, wherein the information other than the user-selected information is selected from textual elements and graphical elements in proximity to the user-selected information in the graphical user interface.

7. The computer-implemented method of claim 5, wherein the information other than the user-selected information is selected from a characteristic of the electronic device and a location of the electronic device.

8. The computer-implemented method of claim 1, further comprising, prior to (V) of claim 1,
sending, by the server to the electronic device via the communications network, instruction to display, by the electronic device in the graphical user interface in respect of the user-selected information, a graphical element indicating a presence of the browser contextual assistant; and
receiving, by the server from electronic device via the communications network, an indication of selection of the graphical element indicating the present of the browser contextual assistant by a user of the electronic device.

9. The computer-implemented method of claim 1, further comprising, after (V) of claim 1,
receiving, by the server from the electronic device via the communications network, a user-selected one of the menu item and the data;
taking an action, by the server, in response to the received user-selected one of the menu item and the data; and
sending, by the server to the electronic device via the communications network, information related to the taken action.

10. A computer-implemented method for providing a browser contextual assistant in a graphical user interface on a display screen of an electronic device, the electronic device having a user input device, the method comprising:
(I) displaying information on the display screen;
(II) receiving from a user of the electronic device via the user input device a selection of at least some of the displayed information, the selection of at least some of the displayed information being part of a web page content displayed on the display screen;
(III) sending, by the electronic device to a server via a communications network, user-selected information;
(IV) receiving by the electronic device from the server the menu element selected by the server from (a) one or more menu items and (b) data for inclusion into a browser contextual assistant, the menu element to be displayed by the electronic device in the graphical user interface in respect of the user-selected information, the menu element having being selected by the server such that:
menu item, if selected, having being selected by the server from a list of menu items having been pre-determined for a given query type of the plurality of query types, the one or more menu items indicating one or more actions to be performed with the user-selected information,
data for inclusion into the browser contextual assistant, if selected, being selected by the server based on a plurality of search results rendered in result of a search being effected with regard to the user-selected information; and
(V) displaying on the display screen a graphical element providing the browser contextual assistant.

11. The computer-implemented method of claim 10, sending, by the electronic device to a server via a communications network, user-selected information includes sending other than the user-selected information.

12. The computer-implemented method of claim 11, wherein the information other than the user-selected information includes at least one of textual elements and graphical elements in proximity to the user-selected information in the graphical user interface.

13. The computer-implemented method of claim 11, wherein the information other than the user-selected information includes at least one of a characteristic of the electronic device and a location of the electronic device.

14. The computer-implemented method of claim 10, wherein the browser contextual assistant includes a non-menu item.

15. The computer-implemented method of claim 10, wherein menu items in the browser contextual assistant are ranked.

16. The computer-implemented method of claim 10, further comprising, prior to (V) of claim 10,
displaying on the display screen a graphical element indicating a presence of the browser contextual assistant; and
receiving from the user of the electronic device via the user input device a selection of the graphical element indicating the present of the browser contextual assistant.

17. The computer-implemented method of claim 10, further comprising, after (V) of claim 10,
receiving from the user of the electronic device via the user input device a user-selected one of the at least one of the menu item and the data;
sending the user-selected one of the at least one of a menu item and data to the server by the electronic device via the communications network;
receiving information from the server by the electronic device via the communications network in response to the sent user-selected one of the at least one of a menu item and data.

18.-34. (canceled)

35. A computer-implemented method for providing a graphical element providing a browser contextual assistant in a graphical user interface on a display screen of an electronic device, the electronic device having a user input device, a computer usable information storage medium, and a processor coupled to the display screen, to the user input device, and to the computer usable information storage medium, the processor being configured to have access to computer readable commands, the method comprising:
(I) receiving, by a server from the electronic device via a communications network, user-selected information appearing in the graphical user interface, the user-selected information appearing in the graphical user interface being part of a web page content displayed on the display screen;
(II) effecting, by the server, a search in a plurality of search verticals in respect of the user-selected information to render a plurality of search results;
(III) based on an analysis of the plurality of search results, determining, by the server, which of the plurality of search verticals is the most relevant search vertical and determining a query type associated with the user-selected text;
(IV) rendering a menu element, the menu element selected from one or more menu items, the menu element to be displayed by the electronic device in the graphical user interface in respect of the user-selected information, the menu element having been selected by the server by executing:
selecting, from a list of menu items, the one or more menu items, the one or more menu items having been pre-determined for a given query type of the plurality of query types, the menu item indicating action to be performed with the user-selected information;
(V) sending, by the server to the electronic device via the communications network, the menu element, the menu element for concurrent displaying with and in association with the user-selected information appearing in the graphical user interface.

36. The computer-implemented method of claim 1, further comprising inserting, into the data for inclusion into the browser contextual assistant, a hyperlink to a publishing source of the data for inclusion into the browser contextual assistant.
